(19) United States
(12) Patent Application Publication
(10) Pub. No.: US 2021/0352849 A1
(43) Pub. Date: Nov. 18, 2021

(54) PLANTER SYSTEM AND LINER THEREFOR

(71) Applicant: Mayumi Turley, San Diego, CA (US)

(72) Inventor: Mayumi Turley, San Diego, CA (US)

(21) Appl. No.: 17/174,668

(22) Filed: Feb. 12, 2021

Related U.S. Application Data
(60) Provisional application No. 63/026,636, filed on May 18, 2020.

(51) Int. Cl. A01G 9/02

(52) U.S. Cl. CPC A01G 9/02

(57) ABSTRACT

The planter system includes a planter with a liner to facilitate evacuation of water from the planter and aeration of the soil within the planter. The liner is made of a durable waterproof material to prevent water from contacting the interior surface of the planter. A filter disposed within the liner serves as a barrier to help prevent solid matter such as soil or other debris within the receptacle from passing into the spout, while allowing water within the receptacle to pass through the filter and into the spout for evacuation from the liner. The spout is configured to pass into an aperture extending through the bottom of the planter. Water and other matter exiting the spout flow into a lined basin. The basin liner may include a drain system to facilitate evacuation of water from within the basin liner.

### CROSS-REFERENCE TO RELATED APPLICATION(S)

This application claims priority to U.S. Provisional Patent Application No. 63/026,636 filed on May 18, 2020, entitled “PLANTER SYSTEM”, the entire disclosure of which is incorporated by reference herein.

### BACKGROUND OF THE INVENTION

### 1. Field of Invention

This invention relates to planters for potted plants. More specifically, it relates to a planter made of wood, bamboo, or other degradable material that includes a protective liner to facilitate aeration of soil within the liner while ensuring proper drainage of water from the liner to prevent damage to the planter.

### 2. Description of Related Art

Planters for planting plants have been used for years to display flowers and other plants in and around homes, offices, etc. Many planters have drain holes for evacuating excess water from the planter. This is done as a precautionary measure in an effort to prevent water damage to the plant. Basins, e.g., saucers, trays, or other open containers, are used for collecting the excess water as it exits the planter.

Planters are constructed using a number of materials for aesthetic and other purposes. Example materials include terracotta or ceramic, clay, resin, concrete, metal, wood, and plastic. Each material has its own unique advantages and disadvantages. For example, while esthetically pleasing, terracotta/ceramic planters are delicate, brittle and very heavy. As such, they have a high incidence of breakage during transport and are expensive to ship. Similarly, while metal and concrete planters tend to be esthetically pleasing, they too tend to be very heavy. Thus, in addition to being expensive to manufacture they are also expensive to transport. Plastic and resin planters are lightweight, easily transportable and cost-effective to manufacture. However, in addition to their lesser esthetic appeal, they oftentimes fade and become brittle in the sun, ultimately resulting in the degradation of the plastic and, hence, cracking of the planter.

Like terracotta, ceramic, metal and concrete planters, wood planters are very esthetically pleasing. Some woods are more durable, i.e., resistant to damage from the elements, e.g., sun, precipitation, etc., than others. However, more durable woods also tend to be more expensive. Due to their less durable nature, i.e., higher susceptibility to damage when exposed to the elements, less expensive woods, such as pine, must be treated with protectants, i.e., preservation chemicals. If left untreated, repeated exposure to the elements will result in accelerated degradation of the wood. In any event, a common feature of all wood, regardless of durability, is that repeated and prolonged exposure to water will degrade the wood over time. As such, wooden planters typically have liners that prevent water and soil from contacting and damaging the wood.

A common issue with wooden planters is the lack of drainage. Most wooden planters have a plastic or metal liner in the bottom of the planter in order to protect the wood from being damaged by water. This is a problem because, other than succulents, all plants need drainage. When a non-succulent plant is planted in a planter that has no drainage, and water is put into the planter, the plant's roots will rot, killing the plant. Thus, most wooden planters are not suitable for growing healthy plants.

In an effort to address the foregoing issue with wooden planters, some wooden planters are treated to prevent water from damaging the wood. The goals of treating the wood include elimination of the liner and the introduction of a drain for evacuating excess water. A drainage opening (usually a standard drain hole) is disposed through the bottom of the wooden planter. By introducing the drain hole, as long as the protectant is reapplied as needed, the wood is not damaged and plants can live relatively healthy in the wooden planter. However, the problem with these protectants is the time, cost, and space needed for application. Multiple coats of the protectant must be applied to the wood and the wood must be dried after each coat. Some protectants require in excess of ten coats to be applied in order to be effective to protect the wood. This is usually a long and relatively expensive process. Additionally, the protectant must be reapplied every year or so, thereby making it difficult to maintain the wood in a condition that water will not damage the wood. As such, treatment of wood is not a very practical way to prevent water from damaging the wood planter.

Based on the foregoing, there is a need in the art for a protective liner for planters made of wood, bamboo, and/or other degradable material(s) that facilitates aeration of soil within the liner while ensuring proper drainage of water from the liner to prevent damage to the planter.

### SUMMARY OF THE INVENTION

The present invention includes a planter with a liner made of a durable waterproof material, e.g., plastic, metal, fiberglass, or resin, to prevent moisture within the liner from contacting the interior surface of the planter. The liner includes a receptacle for receiving a plant. A spout extends downward from the receptacle. A filter disposed within the liner serves as a barrier to help prevent solid matter such as soil or other debris within the receptacle from passing into the spout, while allowing water within the receptacle to pass through the filter and into the spout for evacuation from the liner. Air entering the open bottom of the spout is able to pass through the filter and into the receptacle to facilitate aeration of soil and roots within the receptacle. The spout is dimensionally configured to pass into an aperture extending through the bottom of the planter and allows water to be evacuated from the liner without contacting the planter. In various embodiments, when the liner is seated in the planter, a lower end of the spout is disposed below an exterior bottom surface of the planter.

In various embodiments, the planter system also includes a basin with a liner configured to seat within the basin. The basin liner is configured to receive a lower portion of the planter, such that water and other matter exiting the spout flow into the basin liner. In various embodiments, the basin liner has a spout for evacuating water contained within the basin liner. The spout is configured to pass through an aperture in the basin. A plug or other shutoff mechanism, e.g., shutoff valve, may be used to obstruct the flow of liquid through the basin liner spout.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a side sectional view of the planter, according to various embodiments of the present invention;

FIG. 2 shows a bottom plan view of the planter, according to various embodiments of the present invention;

FIG. 3 shows a side sectional view of the planter liner, according to various embodiments of the present invention;

FIG. 4 shows a bottom plan view of the planter liner, according to various embodiments of the present invention;

FIG. 5 shows a side sectional view of the planter liner seated within the planter, according to various embodiments of the present invention;

FIG. 6 shows a side sectional view of the basin, according to various embodiments of the present invention;

FIG. 7 shows a side sectional view of the basin liner, according to various embodiments of the present invention;

FIG. 8 shows a side sectional view of the basin liner seated within the basin, according to various embodiments of the present invention; and

FIG. 9 shows a side sectional view of the basin liner seated within the basin, according to various embodiments of the present invention.

### DETAILED DESCRIPTION OF PREFERRED EMBODIMENTS

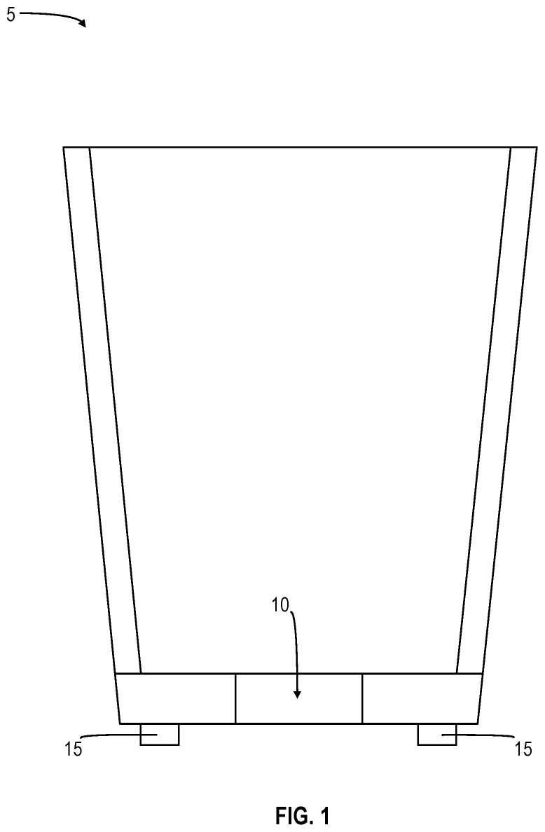

Preferred embodiments of the present invention and their advantages may be understood by referring to FIGS. 1-9, wherein like reference numerals refer to like elements.

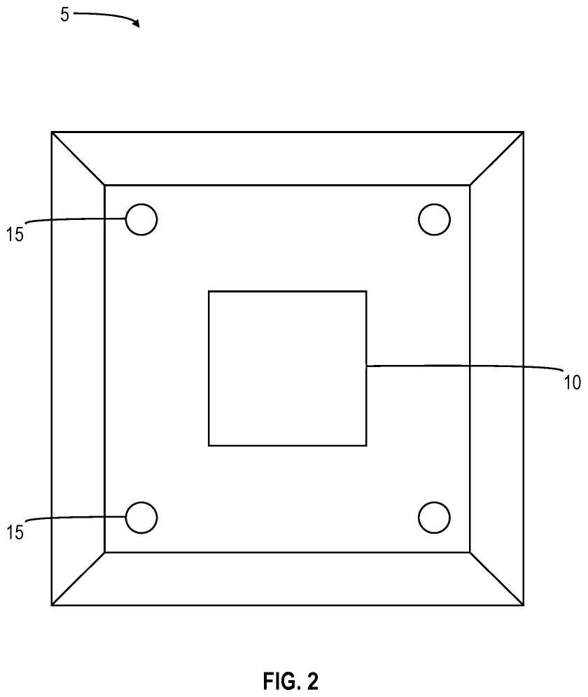

With reference to FIGS. 1-2, the top of planter 5 is open and provides access to the interior of planter 5. Aperture 10 extends through the bottom of planter 5. In a preferred embodiment, planter 5 includes feet 15 to elevate planter 5 from a surface on which planter 5 is placed. Feet 15 may be removably connected to planter 5, e.g., by screws or other non-permanent, i.e., removable, connectors. Alternatively, feet 15 may be integrally formed as part of planter 5, e.g., by a molding, carving, or machining process, such that they are in continuous, unitary construction with one or more exterior surface(s) of planter 5. Feet 15 are preferably constructed of a material that is not adversely affected by prolonged exposure to water. Example materials that may be used for constructing feet 15 include, but are not limited to, rubber, plastic, and silicone.

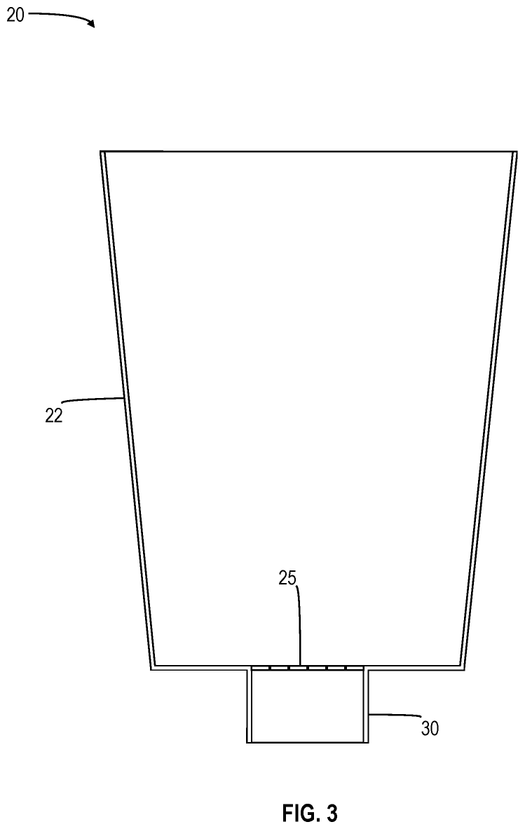

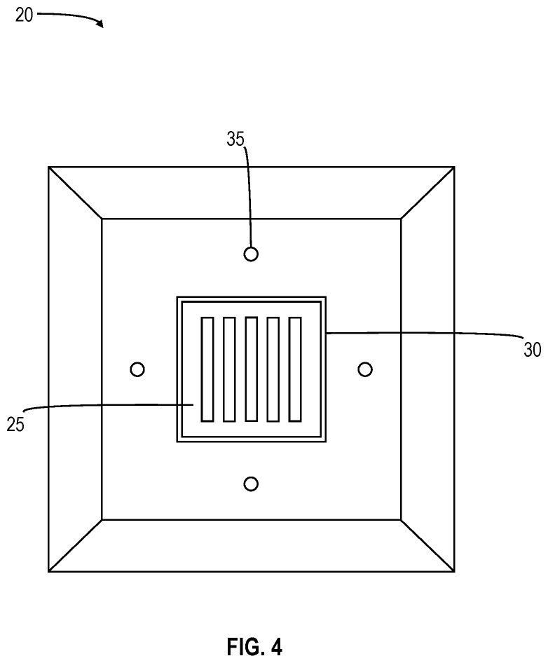

With reference to FIGS. 3-4, liner includes receptacle 22, filter 25, and spout 30. Receptacle 22 has an open top for receiving a plant. Spout 30 extends downward from receptacle 22 and may be fixedly, i.e., permanently, attached to receptacle 22 (e.g., using an adhesive or other permanent joining means) or integrally formed as part of liner 20 (e.g., through a machining or molding process, such that spout 30 is in continuous, unitary construction with receptacle 22). Alternatively, spout 30 may be removably attached to receptacle 22 via mated threading or other releasable attachment mechanism, such as a snap fit or friction fit. Filter 25 serves as a barrier to help prevent solid matter such as soil or other debris within receptacle 22 from passing into spout 30. Water within receptacle 22 is able to pass through filter 25 and into spout 30 for evacuation from liner 20 through the open bottom of spout 30. Similarly, air entering the open bottom of spout 30 is able to pass into receptacle 22, through filter 25, to facilitate aeration of soil and roots within receptacle 22. Filter 25 may be in any form suitable for serving its function, e.g., a mesh, screen, grate, vent, or other perforated configuration. Filter 25 may be fixedly, i.e., irremovably, attached to receptacle 22 (e.g., using an adhesive or other permanent joining means) or integrally formed as part of receptacle 22 (e.g., through a machining or molding process, such that filter 25 is in continuous, unitary construction with receptacle 22). Alternatively, filter 30 may be seated into receptacle 22 and/or removably attached to receptacle 22 using screws or other releasable connectors or via mated threading or other releasable attachment mechanism, e.g., a snap fit or friction fit, between receptacle 22 and filter 25. In some embodiments, as shown in FIG. 4, feet 35 protrude from the bottom of receptacle 22 to create an air space between liner 20 and planter 5. The air space aids in the evacuation or evaporation of water or debris that may get into the area between liner 20 and planter 5.

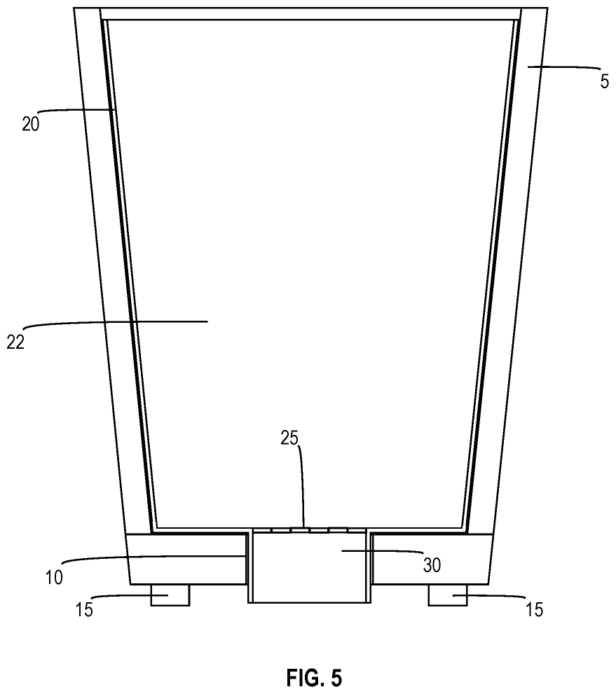

With reference to FIG. 5, planter 5 is dimensionally configured to receive liner 20. As liner 20 is received into planter 5, spout 30 is configured to align with, and pass into, aperture 10 to facilitate seating of liner 20 in planter 5. Spout 30 is configured to evacuate water from liner 20 without allowing the water to contact planter 5. For example, as exemplified in FIG. 5, in a preferred embodiment, when liner 20 is seated in planter 5, a lower end of spout 30 protrudes from the bottom of aperture 10, i.e., below the bottom surface of planter 5. The height of feet 15 is greater than the height of spout 30 protruding below the bottom surface of planter 5 to prevent spout 30 from contacting the surface on which planter 5 is placed.

In an embodiment, as shown in FIG. 5, when liner 20 is fully seated in planter 5, the top edge of liner 20 is disposed below the top edge of planter 5 to allow liner 20 to be concealed during use. In such an embodiment, the outer edge of the top of liner 20 preferably, but not necessarily, engages the inner wall of planter 5 to prevent water or other debris from passing into the area between liner 20 and planter 5. In other embodiments (not shown), when liner 20 is fully seated in planter 5, the top edge of liner 20 extends slightly above, and extends or cups over, the top edge of planter 5 to prevent water or other debris from passing into the area between liner 20 and planter 5.

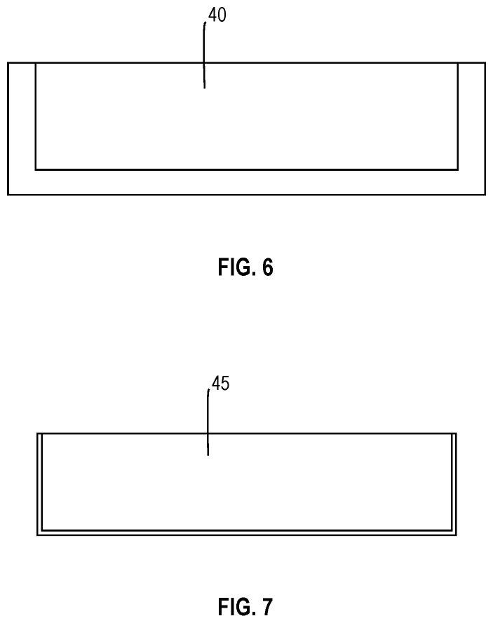

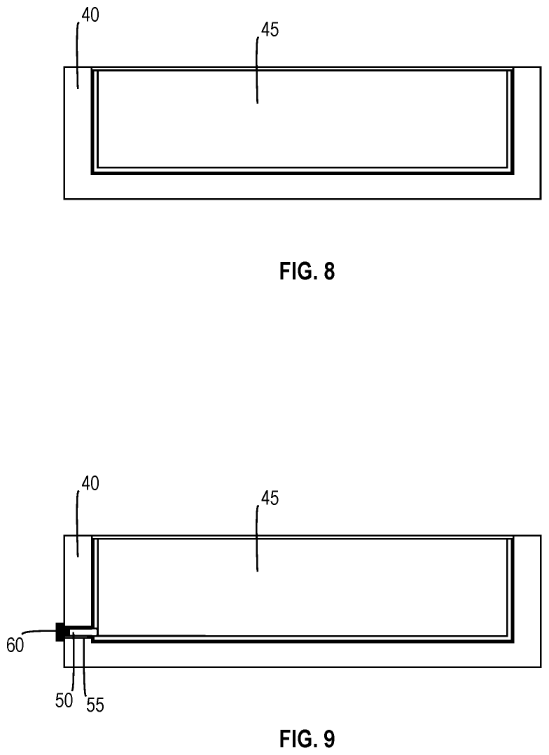

With reference to FIGS. 6-9, basin 40 is dimensionally configured to receive liner 45. In an embodiment, as shown in FIGS. 8-9, when liner 45 is fully seated in basin 40, the top edge of liner 45 is disposed below the top edge of basin 40 to allow liner 45 to be concealed during use. In such an embodiment, the outer edge of the top of liner 45 preferably, but not necessarily, engages the inner wall of basin 40 to prevent water or other debris from passing into the area between liner 45 and basin 40. In other embodiments (not shown), when liner 45 is fully seated in basin 40, the top edge of liner 45 extends slightly above, and extends or cups over, the top edge of basin 40 to prevent water or other debris from passing into the area between liner 45 and basin 40.

Basin 40 with liner 45 inserted is dimensionally configured to receive a lower portion of planter 5. Feet 15 are configured to elevate planter 5 to a level sufficient to prevent the bottom surface of planter 5 from contacting water collected in liner 45. In use, water evacuated through spout 30 is deposited into liner 45 where it collects until emptied. With reference to FIG. 9, in some embodiments liner 45 includes a drain system for draining water from liner 45. Drain system eliminates the need for removing planter 5 from basin 40 to empty water from liner 45. This would be useful, especially with larger/heavier plants. In an embodiment, spout 50 extends from a lower portion of liner 45. Spout 50 extends through aperture 55 in basin 40. In some embodiments, spout 50 connects to an extension drain hose (not shown), allowing water to drain from liner 45, as needed. Additionally, or alternatively, plug 60 may be used to plug spout 50. Plug 60 can be removed, as needed, to drain water from liner 45.

Liners 20, 45 are preferably, but not necessarily, constructed of a rigid or semi-rigid material and are pre-formed such that the exterior dimensional aspects of liner 20 and liner 45 complement the interior dimensional aspects of planter 5 and basin 40, respectively. The material used for constructing liners 20, 45 is impermeable to shield planter 5 and basin 40 from moisture within liners 20, 45.

This system is designed for planters and basins made of wood and other materials that may be adversely affected by prolonged exposure to water. However, it is not meant to be limited to planters and/or basins made of such materials. Similarly, while the description and figures may describe and/or depict elements of the invention in a particular size or shape, that is provided for illustrative purposes only and is not meant to limit the scope of the invention in any way. As such, the elements of the invention described and shown herein can be configured in any shape or size.

The invention has been described herein using specific embodiments for the purposes of illustration only. It will be readily apparent to one of ordinary skill in the art, however, that the principles of the invention can be embodied in other ways. Likewise, it will be readily apparent that the features, functions, and/or elements of the present invention disclosed herein can be used in any combination to produce various embodiments of the present invention. Therefore, the invention should not be regarded as being limited in scope to the specific embodiments disclosed herein, but instead as being fully commensurate in scope with the following claims.

I claim:

1. A planter system comprising:
a. a planter, wherein an aperture extends through a bottom of the planter; and
b. a liner comprising:
i. a receptacle;
ii. a spout extending from a bottom of the receptacle; and
iii. a filter disposed at a lower portion of the receptacle, wherein the filter provides communication between an interior of the receptacle and an interior of the spout,
wherein an interior of the planter is configured to receive at least a portion of the receptacle, wherein at least a portion of the spout is disposed within the planter aperture when the at least a portion of the receptacle is disposed within the planter.

2. The system of claim 1, wherein, when the at least a portion of the receptacle is disposed within the planter, a lower end of the spout is disposed below an exterior bottom surface of the planter.

3. The system of claim 1, wherein the spout is in unitary construction with the receptacle.

4. The system of claim 1, wherein the spout is removably attached to the receptacle.

5. The system of claim 1, wherein the filter is in unitary construction with the receptacle.

6. The system of claim 1, wherein the filter is removably attached to the receptacle.

7. The system of claim 1, wherein the receptacle comprises a plurality of feet.

8. The system of claim 1, wherein the planter is made of wood or bamboo.

9. The system of claim 1, wherein the planter comprises a plurality of feet, wherein the system further comprises:
a. a basin; and
b. a basin liner, wherein at least a portion of the basin liner is configured to seat within the basin, wherein the basin liner is configured to receive a lower portion of the planter.

10. The system of claim 9, wherein at least one of the planter and the basin are made of wood or bamboo.

11. The system of claim 9, wherein the basin liner comprises a spout that passes through a wall of the basin.

12. The system of claim 11, further comprising a plug configured to obstruct a flow of liquid through the basin liner spout.

13. A planter liner comprising:
i. a receptacle;
ii. a spout extending from a bottom of the receptacle; and
iii. a filter disposed at a lower portion of the receptacle, wherein the filter provides communication between an interior of the receptacle and an interior of the spout,
wherein at least a portion of the receptacle is configured to be received into a planter, wherein at least a portion of the spout is configured to pass into an aperture at a bottom of the planter as the at least a portion of the receptacle is received into the planter.

14. The liner of claim 13, wherein, when the at least a portion of the receptacle is received in the planter, a lower end of the spout is disposed below an exterior bottom surface of the planter.

15. The liner of claim 13, wherein the spout is in unitary construction with the receptacle.

16. The liner of claim 13, wherein the spout is removably attached to the receptacle.

17. The liner of claim 13, wherein the filter is in unitary construction with the receptacle.

18. The liner of claim 13, wherein the filter is removably attached to the receptacle.

19. The liner of claim 13, wherein the receptacle comprises a plurality of feet.
